(19) United States
(12) Patent Application Publication
(10) Pub. No.: US 2010/0287948 A1
(43) Pub. Date: Nov. 18, 2010

(54) UNLOADED SPEED CONTROL FOR AVAILABILITY IMPROVEMENTS TO HEAVY FUEL FIRED GAS TURBINES

(75) Inventors: Sam David Draper, Simpsonville, SC (US); Douglas Edward Dean, Greer, SC (US); Alan Meier Truesdale, Greenville, SC (US); Joseph Michael Harvey, Greenville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/776,616

(22) Filed: May 10, 2010

Related U.S. Application Data
(60) Provisional application No. 61/178,013, filed on May 13, 2009.

(51) Int. Cl. F02C 7/275

(52) U.S. Cl. 60/778; 60/788

(57) ABSTRACT

Control of gas turbine speed and acceleration during unloaded rotation may limit stresses on components and facilitate timely operational performance. Operation of a torque converter driving a gas turbine shaft from a starter motor provides control over acceleration and speed of the gas turbine shaft. Hydraulic coupling between the input and output of the torque converter is adjusted by draining and refilling the working fluid in a body of the torque converter to control acceleration and speed of the rotor shaft during a first speed range. Vane positioning within the torque converter may be alternated between discrete speed settings to control acceleration and speed of the rotor shaft during a second speed range. A turbine control system with an acceleration schedule may provide control signals for these functions.

### CROSS REFERENCE TO RELATED APPLICATIONS

This application is related and draws priority to U.S. Provisional Patent Application Ser. No. 61/178,013 entitled “AVAILABILITY IMPROVEMENTS TO HEAVY FUEL FIRED GAS TURBINES”, filed on May 13, 2009 and assigned to General Electric Co, which is herein incorporated by reference.

### BACKGROUND OF THE INVENTION

The invention relates generally to gas turbines and more specifically to a method and equipment for controlling speed and acceleration of the gas turbine during unloaded maintenance operations.

The economy of gas turbine operation dictates that gas turbines be available to produce power to the maximum extent possible. However, it is known that planned and unplanned outages for gas turbine preventive maintenance and repair are required over the life of the equipment. It is advantageous to be able to expeditiously shutdown the gas turbine, establish the conditions required to perform the maintenance, and then return to operation quickly after the maintenance is complete. One example of an operation requiring a shutdown, cooldown, startup and heatup of a gas turbine is a turbine water wash of a hot gas path.

In order to burn heavy fuels (crude and residual oil) turbine washes are required. These washes occur every 3 to 17 days depending on the composition of the fuel and other operating and environmental conditions. The traditional wash cycle provides for injection of a wash solution into a combustor and through the hot gas path of the gas turbine. The wash cycle includes a wash, a soak, a rinse, a drain and a dry operation. The wash cycle may last about 1-2 hours. However, the total time conventionally required to shutdown and cooldown the gas turbine, perform the wash cycle, and then return the gas turbine to base load may take up to about 45 hours. In large part, the overall length from shutdown of the gas turbine to a return to base load is limited by allowing a non-forced cooldown to about 150 degrees F. in order to avoid thermal stresses and reduced life for the turbine rotor, the compressor rotor and the casings.

It is extremely costly for the power plant operator to have gas turbines out of service for the turbine wash cycle about 45 hours every 3 to 17 days Further, the operation of the wash cycle requires significant manpower over an extended period of time to support the wash cycle operation and the gas turbine transitioning. These personnel are not normally on duty around the clock.

Accordingly, it is desirable to provide a method and equipment for reducing the outage time for gas turbine operations of shutting down, cooling down, starting up and returning to service, while at the same time limiting thermal stresses on gas turbine components and preventing excessive fatigue or damage to components from transients. More precise control over acceleration and speed of the gas turbine during unloaded rotation may facilitate such outage improvements and limit damage to components.

### BRIEF DESCRIPTION OF THE INVENTION

Briefly in accordance with one aspect of the present invention, a gas turbine speed and acceleration control system for unloaded rotation is provided. The speed control system includes a starter motor with an output shaft, a torque converter operably connected between the output shaft of the starter motor and a shaft of a gas turbine, a working fluid within an enclosed body of the torque converter, and a working fluid drain system and a working fluid fill system for the torque converter, wherein a draining and a refilling of the working fluid in the body of the torque converter controls a speed and acceleration of the gas turbine during unloaded rotation.

According to a second aspect of the present invention, a method is provided for controlling acceleration and speed of a gas turbine during unloaded rotation with torque converter control. The method includes operating a starter motor through a torque converter to drive a rotor of the turbine. Working fluid level is controlled within the torque converter for setting acceleration of the turbine during a first speed range. The method further includes controlling a means for mechanically adjusting coupling between a rotation of the output shaft of the starter motor and a rotation of the gas turbine shaft of the torque converter for setting acceleration of the turbine during a second speed range.

A third aspect of the present invention provides a gas turbine including a gas turbine shaft and a compressor and a speed control system for unloaded rotation of the gas turbine. The speed control system includes a starter motor, a torque converter operably connected between an output shaft of the starter motor and a shaft of a gas turbine, and a working fluid drain and fill system for the torque converter adapted for draining and refilling the torque converter to control speed and acceleration of the gas turbine during one mode of operation. Further included is means for mechanically adjusting coupling between the rotation of the output shaft of starter motor and the rotation of the gas turbine shaft for speed and acceleration control of the gas turbine.

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 illustrates a rotation scheme for a non-operating gas turbine with a starter motor and a torque converter;

FIG. 2 illustrates a first embodiment of a speed and acceleration control system for rotation of a non-operating gas turbine;

FIG. 3 illustrates a second embodiment of a speed and acceleration control system for rotation of a non-operating gas turbine; and

FIG. 4 illustrates a flow chart for a method of controlling speed and acceleration on an unloaded gas turbine driven by a starter motor through a torque converter.

### DETAILED DESCRIPTION OF THE INVENTION

The following embodiments of the present invention have many advantages, including providing speed and acceleration control during unloaded rotation of the gas turbine through new use of a starter motor and torque converter. Enhanced speed and acceleration control during unloaded gas turbine rotation may assist in significantly reducing current outage time for power gas turbines during operations that require a shutdown and cooldown and subsequent startup and heatup of a gas turbine or individual parts thereof. Such speed and acceleration control may allow decreased duration of the outages, including forced cooling of the system that was heretofore avoided. Such speed and acceleration control over the unloaded gas turbine rotation may assist in maintaining the life of the compressor and turbine rotor, casings, starting means, and exhaust system by limiting speed and acceleration induced stresses that could otherwise add to thermal stresses associated with heatup and cooldown operations.

U.S. patent application Ser. No. 12/767,134 by Draper et al., entitled “AVAILABILITY IMPROVEMENTS TO HEAVY FUEL FIRED GAS TURBINES”, filed on Apr. 26, 2010 and assigned to General Electric Co. provides an inventive method for a gas turbine shutdown, cooldown and return to operation turbine. The method and equipment are provided to reduce the overall cycle time for the maintenance, yet mitigate the life penalties, thereby providing greater power production while maintaining (or potentially extending) rotor life. The method includes small hold times during the turbine shutdown and startup and slower turbine ramp rates during cooldown and startup, which more than offset thermal stresses from a forced cooldown, considerably shortening the overall operation. The method of Draper et al. (Ser. No. 12/767,134) is employed for performing a turbine wash cycle from an operating condition at baseload through a return to baseload operation. However, the method may be more broadly employed for a variety of operations necessitating cooldowns to maintenance conditions and restoration to turbine operation. It should also be understood that parts of the method may be employed without performance of the full method.

The present invention facilitates speed and acceleration control during operations, such as those described in Draper et al. (Ser. No. 12/767,134) requiring unloaded gas turbine rotation. Such speed and acceleration control may minimize thermal stress on limiting gas turbine components and extend life of these components and at the same allow operations to be performed more expeditiously.

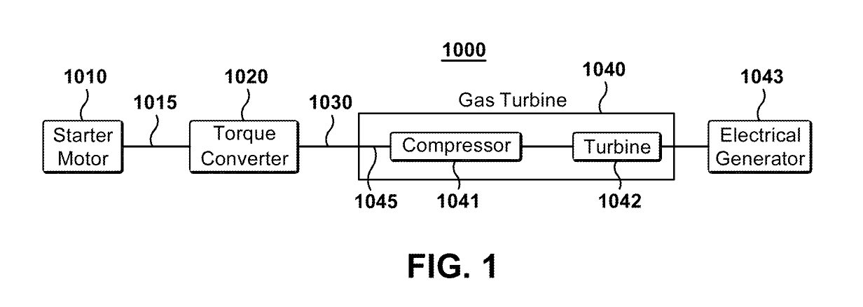

FIG. 1 illustrates a rotation scheme for a non-operating gas turbine with a starter motor and a torque converter. As previously described, the starter motor (1010) through the torque converter (1020) may drive the shaft (1045) of the unloaded gas turbine (1040). The gas turbine (1040) may include a compressor section (1041) and a turbine (1042). The gas turbine (1040) may be rotatingly connected to electrical generator (1043). The starter motor (1010) is tied to an input side of the torque converter (1020) through an starter motor output shaft (1015). The torque converter (1020) is tied to the gas turbine (1040) through an output shaft (1030). The starter motor (1010) may be a constant speed motor (such as 3600 rpm for 60 Hz or 3000 rpm for 50 Hz operation). An on-off control (not shown) may be provided for the motor with over-temperature protection other control features.

The present invention provides a gas turbine speed and acceleration control system for unloaded rotation. The system includes a starter motor with an output shaft and a torque converter operably connected between the output shaft of the starter motor and a gas turbine shaft. A working fluid is provided within an enclosed body of the torque converter. A working fluid drain system and a working fluid fill system for the torque converter, is provided such that a draining and a refilling of the working fluid in the body of the torque converter controls a speed and acceleration of the gas turbine. In a further aspect of the invention, coupling between the input and output of the torque converter may be adjusted with discrete vane settings that may be alternated to control a speed and acceleration of the unloaded gas turbine.

The torque converter is rotatingly connected through the body to the output shaft of the starter motor and includes means for spinning the working fluid within the body. The torque converter is also rotatingly connected through the body to the gas turbine shaft and includes means for rotating the gas turbine shaft by extracting work from the spinning of the working fluid within the body. The torque converter further includes means for mechanically adjusting coupling between the rotation of the output shaft of starter motor and the rotation of the gas turbine shaft by adjusting vanes within the fluid flow path.

In a first embodiment of the torque converter, the means for spinning the working fluid within the body includes a first set of vanes rotatingly connected to the output shaft of the starter motor. For the first embodiment, the means for rotating the gas turbine shaft by extracting work from the spinning of the working fluid within the body includes a second set of vanes rotatingly connected to the gas turbine shaft. The means for mechanically adjusting coupling between the rotation of the output shaft of starter motor and the rotation of the gas turbine shaft may include a linkage changing an orientation of the vanes of either of the first set of vanes and the second set of vanes according to discrete settings of the vanes.

In a second embodiment of the torque converter, an impeller or pump wheel that is rotatingly connected to the output shaft of the starter motor spins the working fluid within the body. The means for rotating the gas turbine shaft by extracting work from the spinning of the working fluid within the body includes one or more turbine wheels rotatingly connected to the gas turbine shaft and a set of guide vanes interposed between a discharge of the impeller and the turbine wheel such that the orientation of the guide vanes variably couples the spinning fluid with the turbine wheels. The means for mechanically adjusting coupling between the rotation of the output shaft of starter motor and the rotation of the gas turbine shaft includes changing an orientation of the guide vanes according to discrete settings.

The means for mechanically adjusting coupling may include discrete linkage settings corresponding to orientation of the adjustable vanes or the movable guide vanes and establishing discrete output speed settings of the gas turbine shaft. For the embodiments of the torque converter, three discrete linkage settings establishing three discrete speeds for the gas turbine shaft may be provided. The linkage settings may be controlled by an output from a turbine control system.

A first operating mode may be provided for a speed control system. The first operating mode may include a first setting of the means for mechanically adjusting coupling between the rotation of the output shaft of starter motor and the rotation of the gas turbine shaft and a filling of the working fluid level within the body for accelerating the gas turbine. The gas turbine speed control for the first operating mode also includes a draining of the working fluid level within the body for slowing the acceleration of the gas turbine shaft to the first speed. Refilling the working fluid level restores coupling between the input and output and promotes acceleration. Alternating filling and draining of the working fluid level may be employed to control acceleration up to the first speed associated with the first setting of the means for mechanically adjusting coupling.

A second operating mode of the speed control system includes the body of the torque converter remaining full with the working fluid. An alternate positioning between the first setting and the second setting of the discrete settings of the means for mechanically adjusting coupling provides for controlling accelerating the gas turbine to a second speed.

For a third operating mode of speed control, the body of the torque converter remains full with the working fluid. A third setting of the means for mechanically adjusting coupling between the rotation of the output shaft of starter motor and the rotation of the gas turbine shaft provides for accelerating the gas turbine in combination with firing for return to power operation.

The gas turbine speed control system may further include a speed sensor for the gas turbine and a speed and an acceleration measurement for the gas turbine, which may be derived from the speed sensor. A gas turbine control signal may be provided to the drain system and a control signal to the fill system of the torque converter to control speed and acceleration of the gas turbine. The control signal may operate individual drain and fill valves. Alternately, an actuator for a spool valve may be provided to control both drain and fill operations. A control signal may also be provided to the means for mechanically adjusting coupling between the rotation of the output shaft of starter motor and the rotation of the gas turbine shaft of the torque converter to control speed and acceleration of the gas turbine. The means being the linkage to the adjustable vanes of the first embodiment and the guide vanes of the second embodiment.

A turbine control system may receive speed sensor inputs for the gas turbine shaft to determine speed and acceleration. The turbine control system or subsystems thereof may include a speed and acceleration schedule for gas turbine rotor for various defined unloaded rotation operations. The speed and acceleration schedule may be established to limit thermal stress to gas turbine components. The turbine control system or subsystems thereof may include known types of feedback control systems to provide drain/fill signals and alternating speed setting signals to the torque converter to drive the unloaded gas turbine rotor according to the embedded speed and acceleration schedule.

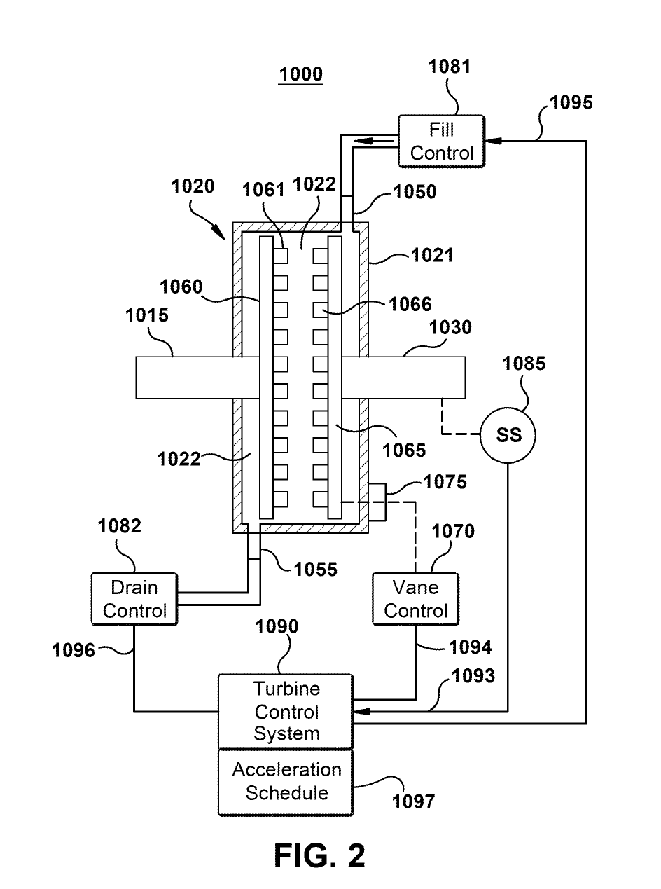

FIG. 2 illustrates a first embodiment for a speed control system (1000) for using the torque converter for rotation of a non-operating gas turbine. The torque converter (1020) uses a working fluid (1022) to transmit load between the starter motor (1010) and the gas turbine rotor (1045) (FIG. 10). The working fluid may be a hydraulic oil or water. The torque converter (1020) includes a body (1021) with cavity (1023) that may be filled with the working fluid (1022). A working fluid inlet (1050) and a working fluid drain (1055) are provided for the cavity (1021). The output shaft (1015) from the starter motor (1010) is rotationally connected to a first rotating plate (1060) within the cavity (1023) of the torque converter (1020). The first rotating plate (1060) includes vanes (1061) to spin the working fluid (1022) within the cavity (1023). The torque converter (1020) further includes a second rotating plate (1065) with vanes (1066). The second rotating plate (1065) is rotationally connected by the output shaft (1030) to the gas turbine rotor (1045). The vanes (1066) on the second rotating plate (1065) may be adjustable with a vane adjustment mechanism (1070) to three settings to extract work from the working fluid (1022). Changing the angle of the vanes (1066) changes the amount of power transmitted between the starter motor (1010) and the gas turbine rotor (1045). Alternatively, the vanes (1061) of the first plate (1060) may be adjustable by the vane adjustment mechanism (1070). The torque converter (1020) works with different speeds of the starter motor (1010). The vane settings (1075) of the torque converter (1020) may be operated by a vane control device (1070).

A turbine control system (1090) may provide vane control signals (1094) to the vane control device (1070) according to a desired schedule for accelerating the turbine rotor in a manner to reduce stress to turbine components. The first speed setting (lowest setting) will turn the rotor to approximately 11% speed at steady state. The second speed setting (middle setting) will turn the rotor to approximately 22% speed. The third speed setting (highest setting) will accelerate the gas turbine rotor during startup to assist the fired turbine in accelerating to full speed no-load (FSNL).

A fill control (1081) may supply working fluid for filling the torque converter (1020) through fill line (1050). A drain control (1082) may drain working fluid from the torque converter (1020) through drain line (1055). Turbine speed and acceleration may be monitored by turbine speed sensor (1085) to a turbine control system (1090). Control signal (1095) for fill control (1081) and control signal (1096) for drain control (1082) may be provided by turbine control system (1090).

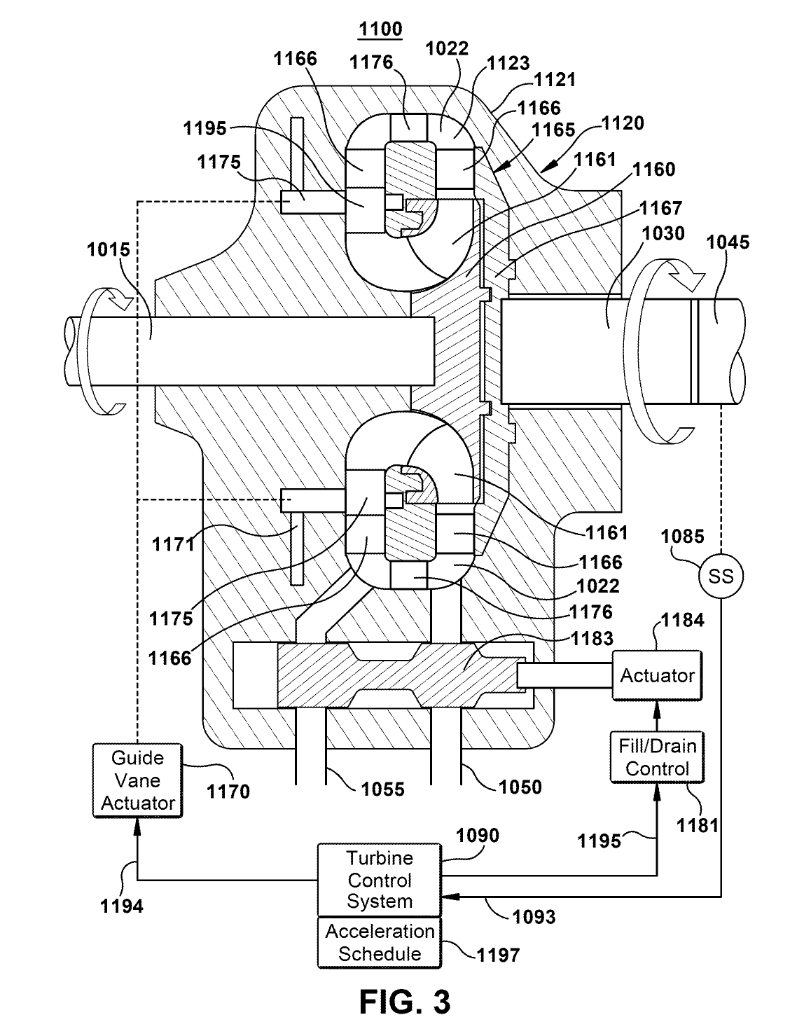

FIG. 3 illustrates operation of a second embodiment for a speed control system (1100) for using the torque converter for rotation of a non-operating gas turbine. The torque converter (1120) uses a working fluid (1022) to transmit load between the starter motor (1010) and the gas turbine rotor (1045) (FIG. 10). The working fluid may be a hydraulic oil or water. The torque converter (1120) includes a body (1121) with cavity (1123) that may be filled with the working fluid (1022). A working fluid inlet (1150) and a working fluid drain (1155) are provided into the cavity (1021). The fill and drain may be controlled with a spool valve (1183) operated by actuator (1184) controlled from the turbine control system (1090). The output shaft (1015) from the starter motor (1010) is rotationally connected to a pump wheel or impeller (1160) within the cavity (1123) of the torque converter (1120). The pump wheel (1160) includes vanes (1161) to spin the working fluid (1022) within the chamber (1021). The torque converter (1120) further includes a rotating turbine wheel (1165) with turbine wheel vanes (1166). The turbine wheel (1165) is rotationally connected by guide plate (1163) to the output shaft (1030) connecting with the gas turbine rotor (1045). The turbine wheel vanes (1166) on the turbine wheel (1165) receive the spinning working fluid (1022) from the pump wheel (1160). Guide vanes (1175) interposed between the pump wheel (1160) and the turbine wheel are adjustable to change coupling therebetween. The guide vanes (1175) may be adjustable with a guide vane actuator (1170) to three settings to extract work from the working fluid (1022). Fixed guide vanes (1176) may also be provided for fixed coupling between the pump wheel (1160) and the turbine wheel (1165). Changing orientation of the guide vanes (1175) changes the power transmitted between the starter motor (1010) and the gas turbine rotor (1045). The guide vanes may be operated by a guide vane actuator (1170) through a linkage (1171). The torque converter may also include fixed guide vanes coupling the working fluid between the pump impeller vanes (1161) and the turbine wheel vanes (1166) The torque converter (1120) may work with different speeds of the starter motor (1010).

Gas turbine rotor speed may be monitored by turbine speed sensor (1085) supply speed signal (1093) to a turbine control system (1090) for use in speed and acceleration calculations. The turbine control system (1090) may provide vane control signals (1194) to the guide vane actuator (1170) according to an embedded schedule (1197) for speed and acceleration of the turbine rotor in a manner to reduce stress to turbine components. The first speed setting (lowest setting) will turn the rotor to approximately 11% speed at steady state. The second speed setting (middle setting) will turn the rotor to approximately 22% speed. The third speed setting (highest setting) will accelerate the gas turbine rotor during startup to assist the fired turbine in accelerating to full speed no-load (FSNL).

A fill/drain control (1181) may supply working fluid for filling the torque converter (1120) through fill line (1050) and drain line (1155). Control signal (1195) for fill/drain control may be provided by turbine control system (1090).

A method is provided for using the torque converter powered by the starter motor to slow the acceleration of the gas turbine rotor and control speed. A two-step control strategy is provided for control of acceleration and speed according to a speed and acceleration schedule within the turbine control system. A first control mode may be applied from zero speed to the first speed setting (approximately 11%). The torque converter power may be modulated in this range, according to a speed and acceleration schedule in the turbine control system, by draining and refilling the working fluid in the system. The torque converter may start filled, when the speed and acceleration of the turbine shaft meets a specific level, the torque converter will drain. To raise acceleration and speed, the torque converter will re-fill.

Once the first speed setting on the torque converter is reached, a brief hold may occur. The torque converter control methodology will change between the first speed (approximately 11% speed) and second speed (approximately 22% speed). Acceleration between the first speed and the second speed for torque converter may be controlled by shifting the vane positions between the first speed setting and the second speed setting, where the second speed setting will raise the acceleration and the first speed setting will lower the acceleration.

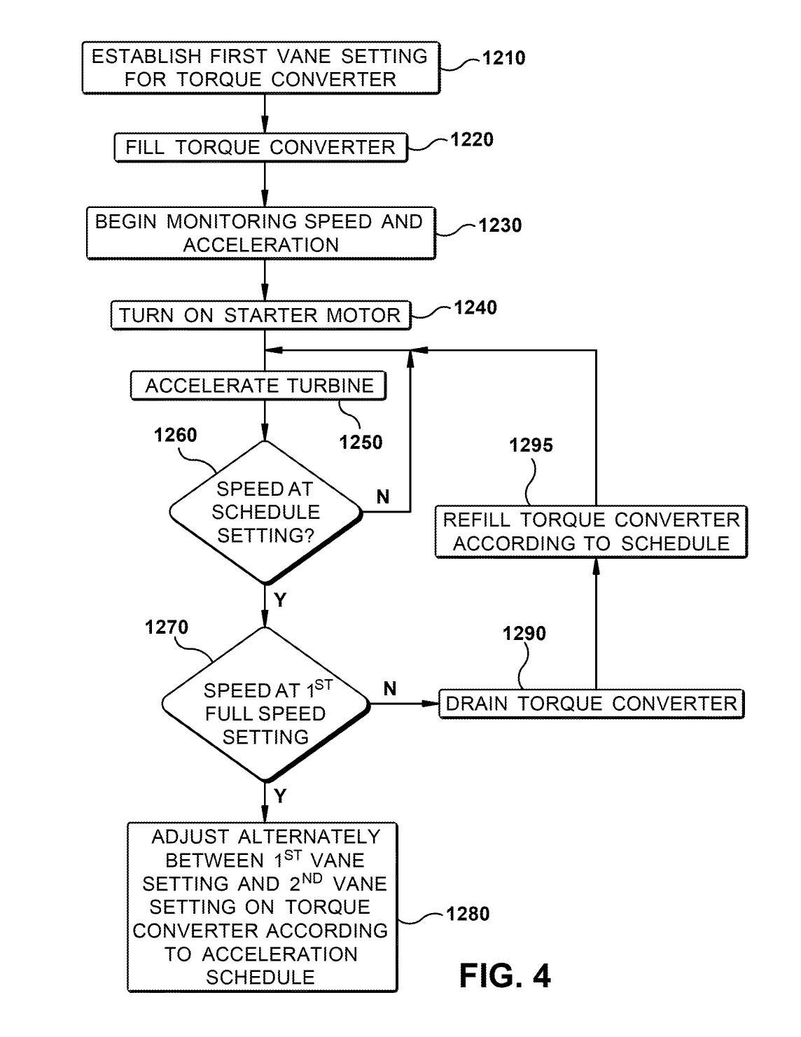

FIG. 4 illustrates a flow chart for a method of controlling speed on an unloaded gas turbine driven by a starter motor through a torque converter. In step 1210, a first vane setting for the torque converter is established. In step 1220, the torque converter is filled with working fluid, if not already filled. Monitoring of gas turbine acceleration and speed is initiated in step 1230. The starter motor is turned on in step 1240. The turbine begins to accelerate in step 1250 as power is transmitted through the torque converter to the turbine rotor. The speed and acceleration of the gas turbine may be compared against a schedule embedded in the turbine control system and established to limit stress on the gas turbine components in step 1260. If the speed has not reached a schedule of speed, then acceleration continues according to step 1250. If the speed in step 1260 has reached the scheduled speed, then a check is made in step 1270 to determine if the speed is at the full speed setting for the first vane setting on the torque converter. If the full first speed setting has been achieved in step 1270, then the vane setting for the torque converter is alternately adjusted between the first speed setting and the second speed setting to control acceleration up to the speed for the second speed setting. Positioning the vanes to the first speed setting will lower the acceleration of the rotor. Positioning the vanes to the second speed setting will raise the acceleration of the rotor. The adjustment to the vane setting may be established according to a schedule for limiting stress on gas turbine components. In step 1270, if the first full speed setting has not been reached, then the torque converter is drained in step 1290 to slow the acceleration according to a schedule. The acceleration is reestablished in step 1295 by refilling the torque converter with working fluid.

A further aspect adds additional speed points between zero speed (ratchet) after shutdown, and 22% speed (currently used for forced cool down). Speed control may be enhanced by modulating the working fluid level in the torque converter for speed and acceleration control between 0 and 11% speed (the first vane setting), and shifting vane settings for speed and acceleration control between 11% and 22% (the second vane setting).

While various embodiments are described herein, it will be appreciated from the specification that various combinations of elements, variations or improvements therein may be made, and are within the scope of the invention.

1. A gas turbine speed control system for unloaded rotation, the system comprising:
a starter motor with an output shaft;
a torque converter operably connected between the output shaft of the starter motor and a gas turbine shaft;
a working fluid within an enclosed body of the torque converter; and
a working fluid drain system and a working fluid fill system for the torque converter, wherein a draining and a refilling of the working fluid in the body of the torque converter controls a speed and acceleration of the gas turbine shaft.

2. The gas turbine speed control according to claim 1, the torque converter comprising:
means, rotatingly connected through the body to the output shaft of the starter motor, for spinning the working fluid within the body;
means, rotatingly connected through the body to the gas turbine shaft, for rotating the gas turbine shaft by extracting work from the spinning of the working fluid within the body;
means for mechanically adjusting coupling between the rotation of the output shaft of starter motor and the rotation of the gas turbine shaft; and
a controllable working fluid level within the body coupling the rotation of the gas turbine shaft to the output shaft of the starter motor.

3. The gas turbine speed control system according to claim 2, wherein:
the means for spinning the working fluid within the body comprise a first plurality of vanes rotatingly connected to the output shaft of the starter motor;
the means for rotating the gas turbine shaft by extracting work from the spinning of the working fluid within the body comprise a second plurality of vanes rotatingly connected to the gas turbine shaft; and
the means for mechanically adjusting coupling between the rotation of the output shaft of starter motor and the rotation of the gas turbine shaft comprise changing an orientation of the vanes of one of the first plurality of vanes and the second plurality of vanes according to a plurality of discrete settings of the vanes.

4. The gas turbine speed control system according to claim 2,
the means for spinning the working fluid within the body comprise an impeller rotatingly connected to the output shaft of the starter motor;
the means for rotating the gas turbine shaft by extracting work from the spinning of the working fluid within the body comprise at least one a turbine wheel rotatingly connected to the gas turbine shaft and a plurality of guide vanes interposed between a discharge of the impeller and the turbine wheel; and
the means for mechanically adjusting coupling between the rotation of the output shaft of starter motor and the rotation of the gas turbine shaft comprise changing an orientation of the guide vanes according to a plurality of discrete settings of the guide vanes.

5. The gas turbine speed control system according to claim 4, comprising a first operating mode including:
a first setting of the means for mechanically adjusting coupling between the rotation of the output shaft of starter motor and the rotation of the gas turbine shaft; and
a filling of the working fluid level within the body for increasing acceleration of the gas turbine shaft.

6. The gas turbine speed control system according to claim 5, the first operating mode further comprising:
a draining of the working fluid level within the body for slowing the acceleration of the gas turbine shaft.

7. The gas turbine speed control system according to claim 6, the first operating mode further comprising: alternating filling and draining of the working fluid level to control acceleration up to a first speed.

8. The gas turbine speed control system according to claim 7, a second operating mode comprising:
the body of the torque converter full with the working fluid; and
an alternating positioning of the plurality of discrete settings of the means for mechanically adjusting coupling between a first setting and a second setting when the gas turbine shaft is accelerating to the second speed.

9. The gas turbine speed control system according to claim 3, a third operating mode comprises:
the body of the torque converter full with the working fluid; and
a third setting of the plurality of discrete settings of the means for mechanically adjusting coupling between the rotation of the output shaft of starter motor and the rotation of the gas turbine shaft for accelerating the gas turbine in combination with firing for return to power operation.

10. The gas turbine speed control system according to claim 9, further comprising:
A turbine control system;
a speed sensor for the gas turbine shaft providing a speed signal to a turbine control system;
a speed and an acceleration calculation in the turbine control system for the gas turbine shaft;
an acceleration schedule within the turbine control system for a first operating mode and a second operating mode;
a control signal from the turbine control system to a drain system and to a fill system of the torque converter wherein speed and acceleration of the gas turbine shaft is controlled according to the acceleration schedule; and
a control signal from the turbine control system to the means for mechanically adjusting coupling of the torque converter wherein speed and acceleration of the gas turbine shaft is controlled to the to acceleration schedule.

11. A method adapted for controlling speed and acceleration of a gas turbine shaft with torque converter control, the method comprising:
operating a starter motor through a torque converter to drive a the gas turbine shaft;
controlling a working fluid level within the torque converter for setting acceleration of the turbine during a first speed range; and
controlling a means for mechanically adjusting coupling between a rotation of the output shaft of starter motor and a rotation of the gas turbine shaft of the torque converter for setting acceleration of the turbine during a second speed range.

12. The method according to claim 11, the step of controlling a working fluid level comprising:
filling the body of the torque converter to accelerate the gas turbine; and
draining the body of the torque converter to slow acceleration of the gas turbine.

13. The method according to claim 11, the step of controlling a vane position during a second speed range comprising:
maintaining the body of the torque converter full with the working fluid;
setting the means for mechanically adjusting coupling between the rotation of the output shaft of starter motor and the rotation of the gas turbine shaft to a first speed setting to slow acceleration of the gas turbine; and
setting the means for mechanically adjusting coupling between the rotation of the output shaft of starter motor and the rotation of the gas turbine shaft to a higher second speed setting to raise acceleration of the gas turbine.

14. The method according to claim 11, further comprising:
monitoring the speed and acceleration of the according to a speed sensor of the gas turbine.

15. The method according to claim 14, further comprising:
signaling by a turbine control system to a drain control for a drain operation to slow acceleration; and
signalling by the turbine control system to a fill control for a fill operation to raise acceleration.

16. The method according to claim 14, further comprising:
signalling by the turbine control system for a first setting to the means for mechanically adjusting coupling between the rotation of the output shaft of starter motor and the rotation of the gas turbine shaft to slow acceleration; and
signalling by the turbine control system for a second setting to the means for mechanically adjusting coupling between the rotation of the output shaft of starter motor and the rotation of the gas turbine shaft to raise acceleration.

17. The method according to claim 15, further comprising: establishing by the turbine control system of the working fluid level in the torque converter and setting the means for mechanically adjusting coupling between the rotation of the output shaft of starter motor and the rotation of the gas turbine shaft for torque converter according to a desired acceleration of the gas turbine.

18. A gas turbine comprising:
a gas turbine with a gas turbine shaft;
a compressor;
a speed control system for unloaded rotation of the gas turbine including, a starter motor with an output shaft, a torque converter operably connected between the output shaft of the starter motor and a shaft of a gas turbine, a working fluid drain and fill system for the torque converter wherein draining and refilling of the torque converter controls speed of the gas turbine shaft; and means for mechanically adjusting coupling between the rotation of the output shaft of starter motor and the rotation of the gas turbine shaft for speed control of the gas turbine.

19. The gas turbine according to claim 18, the torque converter comprising:
an enclosed body;
means, rotatingly connected through the body to the output shaft of the starter motor, for spinning the working fluid within the body;
means, rotatingly connected through the body to the gas turbine shaft, for rotating the gas turbine shaft by extracting work from the spinning of the working fluid within the body;
means for mechanically adjusting coupling between the rotation of the output shaft of starter motor and the rotation of the gas turbine shaft; a controllable working fluid level within the body coupling the rotation of the gas turbine shaft to the to the output; and
an adjustable water level within the body promoting a coupling between the rotation of the input plate and the rotation of the output plate.

20. The gas turbine according to claim 19, the speed control system further comprising:
a turbine control system;
a speed sensor for the gas turbine shaft;
a speed and acceleration measurement for the gas turbine shaft determined by the turbine control system according to the speed sensor;
speed control signals from the turbine control system to a fill system and a drain system of the torque converter according to an acceleration schedule embedded in the turbine control system;
a fill signal from the turbine control system to the fill system for the torque converter wherein filling of the working fluid level within the body increases acceleration according to the acceleration schedule embedded in the turbine control system for the gas turbine shaft to a first speed setting;
a drain signal from the turbine control system to the drain system for the torque converter wherein lowering the working fluid level within the body slows the acceleration of the means for rotating the gas turbine shaft according to the acceleration schedule embedded in the turbine control system for the gas turbine shaft to a first speed setting;
a control signal from the turbine control system to the control system for the means for rotating the gas turbine shaft by extracting work from the spinning of the working fluid within the body to set a first speed setting to slow acceleration of the gas turbine; and
a control signal from the turbine control system to the control system for the means for rotating the gas turbine shaft by extracting work from the spinning of the working fluid within the body to set a second speed setting to increase acceleration of the gas turbine.
